(19) United States
(12) Patent Application Publication
(10) Pub. No.: US 2026/0159026 A1
(43) Pub. Date: Jun. 11, 2026

(54) Vehicle Control System and Method

(71) Applicants: HYUNDAI MOTOR COMPANY, Seoul (KR); KIA CORPORATION, Seoul (KR)

(72) Inventors: Xi Sha Li, Shandong (CN); Kyong Ho Shon, Hwaseong-si (KR); Jin Shun Li, Shandong (CN); In Sik Chun, Hwaseong-si (KR); Hang Hang Wang, Shandong (CN)

(73) Assignees: HYUNDAI MOTOR COMPANY, Seoul (KR); KIA CORPORATION, Seoul (KR)

(21) Appl. No.: 18/976,801

(22) Filed: Dec. 11, 2024

(30) Foreign Application Priority Data
Dec. 6, 2024 (CN) 202411793092.3

(51) Int. Cl. B60R 25/04; B60R 25/24; G07C 9/00; H04B 17/318

(52) U.S. Cl. CPC B60R 25/04; B60R 25/245; G07C 9/00309; H04B 17/318; B60R 2325/101; B60R 2325/205; G07C 2009/00793; G07C 2209/63

(57) ABSTRACT

According to an embodiment, there is provided a vehicle control system including a server configured to store a positioning pattern for positioning a relative position of a user terminal with respect to a vehicle, the user terminal configured to receive the positioning patterns corresponding to model identification information and user identification information from the server and transmit the positioning patterns to the vehicle, and the vehicle configured to compare a strength of a wireless communication signal received from the user terminal with the positioning pattern to determine the position of the user terminal and control an operation according to the result of position determination.

### CROSS-REFERENCE TO RELATED APPLICATION(S)

This application claims priority to and the benefit of Chinese Patent Application No. 202411793092.3, filed on Dec. 6, 2024, the entire contents of which are incorporated herein by reference.

### TECHNICAL FIELD

Embodiments of the present disclosure relate to a vehicle control system and method.

### BACKGROUND

A passive-entry-passive-start (PEPS) function can estimate a position of a smartphone through a communication module mounted on a vehicle and then automatically perform operations such as door locking/unlocking and starting of the vehicle.

In order for the PEPS function to operate smoothly, tuning and optimization (phone calibration) through signal strength collection and pattern acquisition of the smartphone are implemented (e.g., important).

However, since memory space of the module is limited, a method is used in which a representative phone is selected for each smartphone manufacturer to perform tuning, a basic pattern is set, and the set basic pattern is stored in the memory of the communication module.

However, since there may be various smartphone models out of the basic pattern and a user's smartphone usage situations and habits (e.g., wearing a thick phone case or using the smartphone in a pocket or bag) are also diverse, the actual signal strength of the smartphone may be out of the basic pattern. This makes it challenging to determine an accurate position of the smartphone, potentially resulting in the PEPS function not operating properly.

### SUMMARY

The present disclosure is directed to providing a vehicle control system and method capable of performing active positioning using various signal patterns.

According to an embodiment, there is provided a vehicle control system including a server configured to store a positioning pattern for positioning a relative position of a user terminal with respect to a vehicle, the user terminal is configured to receive the positioning patterns corresponding to model identification information and user identification information from the server and transmit the positioning patterns to the vehicle, and the vehicle is configured to compare a strength of a wireless communication signal (received signal strength indicator (RSSI)) received from the user terminal with the positioning pattern to determine the position of the user terminal and control an operation according to the result of position determination.

The positioning pattern may include a strength range of the wireless communication signal at front, rear, left, and right sides of the vehicle.

The server may search for the positioning patterns corresponding to the model identification information and the user identification information and transmit the positioning patterns to the user terminal upon request from the user terminal.

When the positioning patterns corresponding to the model identification information and the user identification information are not searched, the server may search for a default positioning pattern corresponding to the model identification information and transmit the default positioning pattern to the user terminal.

When the result of the position determination is valid, the vehicle may perform a passive-entry-passive-start (PEPS) control operation.

When the result of the position determination is invalid, the vehicle may transmit a first update request of the positioning pattern to the user terminal.

When the result of the position determination is invalid, the vehicle may generate a new positioning pattern using strengths of signals measured in the position determination process and transmit the new positioning pattern to the user terminal.

The vehicle may apply a strength of a signal having the smallest value among the strengths of the signals measured in the position determination process to generate the new positioning pattern.

The user terminal may transmit a second update request including the model identification information, the user identification information, and the new positioning pattern to the server.

The server may update the stored positioning patterns using the information included in the second update request.

According to an embodiment, there is provided a vehicle control method including requesting, by a user terminal, a positioning pattern from a server, searching for, by the server, a corresponding positioning pattern according to the request and transmitting the positioning pattern to the user terminal, receiving, by the user terminal, the positioning pattern and transmitting the positioning pattern to a vehicle, measuring, by the vehicle, a strength of a wireless communication signal received from the user terminal, comparing, the strength of the signal measured by the vehicle with the positioning pattern and determining a position of the user terminal, and controlling, by the vehicle, an operation according to the result of position determination.

The positioning pattern may include a strength range of the wireless communication signal at front, rear, left, and right sides of the vehicle.

The searching and transmitting of the positioning pattern may include searching for the positioning patterns corresponding to model identification information and user identification information and transmitting the positioning patterns to the user terminal.

The searching and transmitting of the positioning pattern may include searching for a default positioning pattern corresponding to the model identification information and transmitting the default positioning pattern to the user terminal when the positioning patterns corresponding to the model identification information and the user identification information are not searched.

The controlling of the operation may include performing a passive-entry-passive-start (PEPS) control operation when the result of position determination is valid.

The vehicle control method may further include, after the determining of the position, transmitting, by the vehicle, a first update request of the positioning pattern to the user terminal when the result of position determination is invalid.

The transmitting of the first update request may include generating a new positioning pattern using a strength of a signal measured in the position determination process, and transmitting the new positioning pattern to the user terminal according to a response of the user terminal.

The generating of the new positioning pattern may include applying a strength of a signal having the smallest value among the strengths of the signals measured in the position determination process to generate the new positioning pattern.

The vehicle control method may further include, after the transmitting of the first update request, generating, by the user terminal, a second update request including model identification information, user identification information, and the new positioning pattern, and transmitting the second update request to the server.

The vehicle control method may further include, after the transmitting of the second update request to the server, updating, by the server, stored positioning patterns using the information included in the second update request.

### BRIEF DESCRIPTION OF THE DRAWINGS

The above and other objects and features of the present disclosure will become more apparent by describing exemplary embodiments thereof in detail with reference to the accompanying drawings, in which:

FIG. 1 is a view for describing a vehicle according to an embodiment;

FIG. 2 is a block diagram illustrating a configuration of the vehicle according to the embodiment;

FIG. 3 is a block diagram illustrating a configuration of a user terminal according to the embodiment;

FIG. 4 is a conceptual diagram of a vehicle control system according to the embodiment;

FIG. 5 is a view for describing a positioning pattern according to the embodiment;

FIGS. 6, 7, and 8 are views for describing the operation of the vehicle according to the embodiment; and

FIGS. 9 and 10 are flowcharts of vehicle control methods according to embodiments.

### DETAILED DESCRIPTION

Hereinafter, exemplary embodiments of the present disclosure will be described in detail with reference to the accompanying drawings.

However, the technical spirit of the present disclosure is not limited to some of the described embodiments, but may be implemented in various different forms, and one or more of the components among the embodiments may be used by being selectively coupled or substituted without departing from the scope of the technical spirit of the present disclosure.

In addition, terms (including technical and scientific terms) used in embodiments of the present disclosure may be construed as having a meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the embodiments of the present disclosure.

These terms are (e.g., only) for the purpose of distinguishing one component from another component, and the nature, sequence, order, or the like of the corresponding components is not limited by these terms.

In addition, when a first component is described as being “connected,” “coupled,” or “joined” to a second component, it may include a situation in which the first component is (e.g., directly) connected, coupled, or joined to the second component, but also a case in which the first component is “connected,” “coupled,” or “joined” to the second component by other components present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

Hereinafter, embodiments will be described in detail with reference to the accompanying drawings, and the same or corresponding components are denoted by the same reference numeral regardless of the reference numerals, and overlapping descriptions thereof will be omitted.

For purposes of this application and the claims, using the exemplary phrase “at least one of: A; B; or C” or “at least one of A, B, or C,” is used to mean “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, or the like as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any (e.g., or all) of the tangible memory of computers, processors, or the like, or associated modules thereof, such as various semiconductor memories, tape drives, disk drives and the like, which may provide non-transitory storage at any time for software programming.

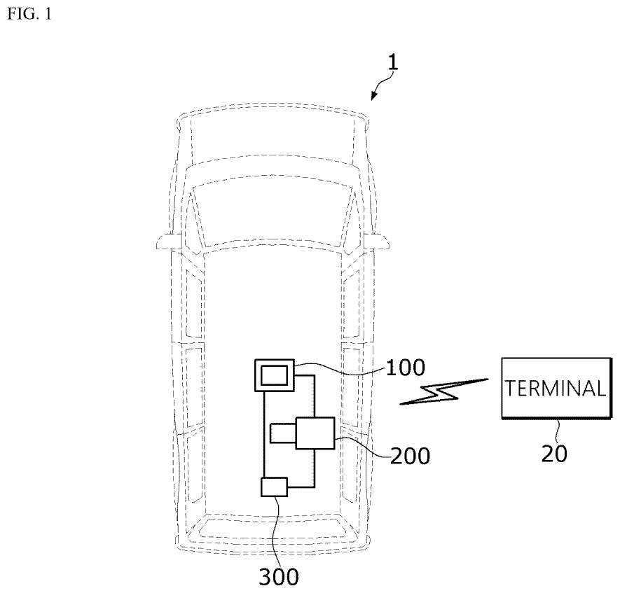

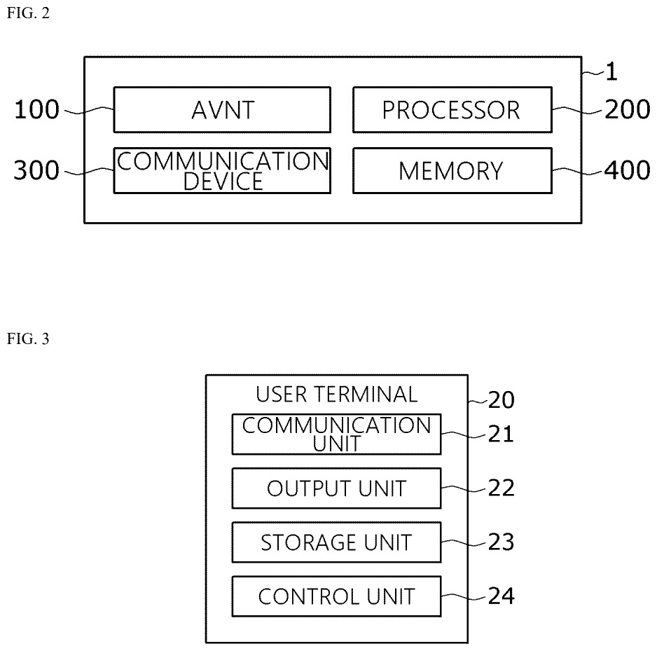

FIG. 1 is a view for describing a vehicle according to an embodiment, and FIG. 2 is a block diagram illustrating a configuration of the vehicle according to the embodiment. Referring to FIGS. 1 and 2, a vehicle 1 according to the embodiment may include an audio video navigation and telematics (AVNT) 100, a processor 200, a communication device 300, and a memory 400.

The vehicle 1 may include the AVNT 100 provided in a (e.g., center) fascia and configured to control an audio device, an air conditioner, a Bluetooth device, a seat heater, and the like.

An input device for receiving a user input may be disposed in the (e.g., center) fascia or the AVNT 100, and a display device for displaying operation information for at least one of functions performed in the vehicle 1 may also be disposed.

The input device may include hardware devices such as various buttons or switches, pedals, a keyboard, a mouse, a track-ball, various levers, a handle, or a stick.

In addition, the input device may include a graphical user interface (GUI), that is, a software device, such as a touch pad. The touch pad may be implemented as a touch screen panel (TSP) to form a mutual layer structure with a display panel of the display device.

The display device may function as a user interface. The display device may display the vehicle's operating state, control state, route/traffic information, energy remaining information, content requested by a driver, and the like by a processor. In addition, the display device may be configured as a touch screen capable of detecting a driver input to receive the driver's request that instructs the processor.

The interior of a vehicle body may include a keyway into which a fob type or card type remote controller may be inserted. Here, the keyway may be provided on a dashboard or (e.g., center) fascia and provided at a position adjacent to a driver's seat.

The vehicle 1 may transmit and receive information with a remote controller or a terminal when the remote controller is inserted into the keyway or when authentication with the remote controller or terminal is completed via a wireless communication network.

The interior of the vehicle body may further include a start button that receives on/off commands. Therefore, the vehicle starts when the start button is pressed by the user after the authentication with the remote controller or terminal is completed.

The vehicle 1 may further include a communication device for transmitting and receiving information with at least one of electronic devices and a terminal 2 that are provided in the vehicle.

The communication device 300 may include one or more components that enable communication between in-vehicle components and for example, may include at least one of a short-range communication module, a wired communication module, and/or a wireless communication module.

For example, the short-range communication module may include various short-range communication modules for transmitting and receiving signals using a wireless communication network at a short distance, such as a Bluetooth module, an infrared communication module, a radio frequency (RF) identification communication module, a wireless local access network (WLAN) communication module, a near-field communication (NFC) communication module, or a Zigbee communication module.

For example, the wired communication module may include not only various wired communication modules such as a controller area network (CAN) communication module, a local area network (LAN) module, a wide area network (WAN) module, and a value added network (VAN) module, but also various cable communication modules such as a universal serial bus (USB), a high definition multimedia interface (HDMI), a digital visual interface (DVI), a recommended standard 232 (RS-232), power line communication, and a plain old telephone service (POTS).

For example, a controller area network (CAN) may include (e.g., comprise) a communication protocol designed for real-time data exchange between microcontrollers and devices within vehicles and industrial systems. CAN may allow multiple electronic control units to communicate with each other without (e.g., the need for) a host computer, making it useful for applications where reliable, high-speed communication is useful (e.g., critical).

For example, a value added network (VAN) may comprise a private network that may provide businesses with secure, reliable communication channels for exchanging data and documents. VANs may offer services (e.g., data encryption, format translation, message routing, or tracking, or the like) to ensure that business documents (e.g., invoices, purchase orders, or shipping notices, or the like) may be transmitted efficiently and/or securely between trading partners.

The wired communication module may further include a local interconnect network (LIN). For example, a local interconnect network (LIN) may comprise a low-cost serial communication protocol that may be used in automotive systems to connect electronic components (e.g., sensors, actuators, or control units, or the like). For example, for simplicity and/or cost-efficiency, LIN may manage functions that do not use (e.g., require) high-speed data transfer (e.g., window controls, seat adjustments, lighting, or climate control, or the like). LIN may function on a single-master, multiple-slave architecture, where one master node may coordinate communication with multiple slave nodes.

In addition, in addition to the Wi-Fi module and the wireless broadband (WiBro) module, the wireless communication module may include a wireless communication module for supporting various wireless communication methods, such as global system for mobile communication (GSM), code division multiple access (CDMA), wideband code division multiple access (WCDMA), universal mobile telecommunications system (UMTS), time division multiple access (TDMA), and long term evolution (LTE).

The user terminal 20 communicates with the vehicle 1, receives at least one of a vehicle door lock and unlock command, a tailgate lock and unlock command, a start command, a lamp lighting command, and a start command as a user input, and transmits information corresponding to the received command to the vehicle. The user terminal 20 may transmit the information corresponding to the received command to the vehicle as a communication signal.

The user terminal 20 may be implemented as a computer or portable terminal that can be communicatively connected to the vehicle via a network.

Here, the computer may include, for example, a notebook, desktop, laptop, tablet PC, slate PC, or the like that is provided with a WEB browser, and the portable terminal is a wireless communication device that ensures portability and mobility and may include, for example, any kind of handheld-based wireless communication device such as a personal communication system (PCS), a GSM, a personal digital cellular (PDC), a personal handyphone system (PHS), a personal digital assistant (PDA), an international mobile telecommunication (IMT)-2000, CDMA-2000, WCDMA, and wireless broadband Internet (WiBro) terminals, and a smartphone, and wearable devices such as a watch, a ring, a bracelet, an anklet, a necklace, glasses, contact lenses, or a head-mounted-device (HMD).

In an embodiment, the user terminal 20 may communicate with the vehicle through a Bluetooth low energy (BLE) communication method. The user terminal 20 may perform communication based on the Bluetooth beacon standard (iBeacon).

The AVNT 100 is the term referring to an in-vehicle information and entertainment system and may be a system that integrates navigation, audio, video, and communication functions. The AVNT 100 may output a message generated by the processor 200 in at least one of a visual manner, an audible manner, or a combination thereof.

The AVNT 100, the processor 200, and the communication device 300 may be implemented as one module, but in the embodiment, will be described separately for convenience of description.

The AVNT 100 may be a component for providing a hardware interface integrated into the system in the vehicle. The AVNT 100 may perform system control for a screen, buttons, and various integrated information and entertainment functions.

The AVNT 100 may be installed at the center or console of the vehicle dashboard to provide vehicle information and an entertainment interface. The information and entertainment system may include AM/FM radio, satellite radio, DVDs/CDs, cassette tapes, USB MP3, dashcams, GPS navigation devices, Bluetooth, Wi-Fi, and the like and also provide the state information of the vehicle system. In addition, the AVNT 100 may perform functions such as voice control and motion recognition.

The processor 200 may control the vehicle body such as a vehicle, doors, windows, or keys (e.g., a digital key, a smartphone key, and a fob). The processor may perform a body control function (BCM), a smart key entry/start function (SMK), a tire air pressure monitoring function (TPMS), an immobilizer function (IMMO), digital key authentication (IAU), an autonomous parking related control function (PDW), and the like. For example, the processor 200 may be a body domain controller (BDC), but is not limited thereto, and may be used to encompass a platform controller for providing electronic convenience functions to a body domain area.

The communication device 300 may perform pairing between the user terminal 20 and the vehicle 1 using a Bluetooth signal.

The communication device 300 may include a transceiver for transmitting and receiving information using an antenna, a communication circuit, a communication processor, and the like and perform short-range communication with the user terminal 20. According to an embodiment, the communication device 300 may perform Bluetooth communication, NFC communication, or UWB communication. The communication device 300 may be provided near a door handle of the vehicle 1 to request authentication information when it is determined that the user terminal approaches within a predetermined distance.

In the Bluetooth standard, Bluetooth 1.0 stipulates that a data transmission rate is 1 Mbps and a transmission distance ranges from 10 m (e.g., meters) to 100 m, and communication is possible even in the presence of obstacles because Bluetooth 1.0 uses a high radio frequency of 2.4 GHz.

The communication device 300 according to the embodiment may measure the position of the user terminal under the control of the processor 200 when the user terminal including a digital key approaches the outside of the vehicle 1, unlock the vehicle door according to the result of positioning, and control the remote start of the vehicle 1.

The communication device 300 may include a plurality of positioning modules 310. The positioning module 310 may be a short-range wireless communication module, and each wireless communication module may measure the strength of a wireless signal received from the user terminal. One of the plurality of wireless communication modules mounted on the vehicle 1 may be set as a master module. The master module may collect the strength of a wireless signal measured by another wireless communication module and transmit the strength to the processor.

For example, the positioning module 310 may be composed of a Bluetooth module, a low-power Bluetooth module, a Wi-Fi module, and the like. The positioning module 310 may be provided at each of the front, rear, left, and right sides of the vehicle 1 and may independently measure the strength of the wireless signal of the user terminal 20 and transmit the strength to the master module.

The processor 200 may perform the overall control of the vehicle 1. The processor 200 may be configured to execute applications and instructions that are stored in the memory 400.

The processor 200 may be a main CPU for overall control of a vehicle control system 10. In an embodiment, the processor 200 may perform a pairing operation by executing a Bluetooth application to perform communication between the Bluetooth application and the communication device.

The processor 200 may determine a relative position of the user terminal 20 with respect to the vehicle 1. In an embodiment, the relative position may include a distance between the vehicle 1 and the user terminal 20 and a direction in which the user terminal 20 is positioned with respect to the vehicle 1.

For example, the processor 200 may determine the relative position using at least one of the Wi-Fi, Bluetooth, and low-power Bluetooth methods.

The processor 200 may compare the positioning result with the positioning pattern and determine the relative position of the user terminal 20.

For example, the processor 200 may determine the relative position between the vehicle and the user terminal using a received signal strength indicator (RSSI) method that measures the strength of a Wi-Fi signal to estimate a distance.

Alternatively, the processor 200 may determine the relative position between the vehicle and the user terminal using the RSSI method that measures the strength of a Bluetooth signal to estimates a distance.

The memory 400 may store an application and various pieces of data for controlling the vehicle 1 and load the application, or read or write the data at the request of the processor 200.

The memory 400 may store at least one algorithm that performs calculation or execution of various commands for operating the vehicle control system 10 according to the embodiment. The memory 400 may include at least one storage medium of a flash memory, a hard disc, a memory card, a read-only memory (ROM), a random access memory (RAM), an electrically erasable programmable ROM (EEPROM), a programmable ROM (PROM), a magnetic memory, a magnetic disc, and an optical disc.

In the following embodiments, an example in which positioning is performed using a Bluetooth signal and a passive-entry-passive-start (PEPS) operation is controlled will be described.

FIG. 3 is a block diagram illustrating a configuration of the user terminal according to the embodiment.

Referring to FIG. 3, the user terminal 20 may include a communication unit 21, an output unit 22, a storage unit 23, and a control unit 24.

The user terminal 20 may include a smartphone, a smart pad, a notebook computer, and the like that the user can carry. The user terminal 20 may store a digital key that generates authentication information for controlling functions such as locking and unlocking of the vehicle door, remote starting, emergency alarm, and trunk opening.

The communication unit 21 may include a transceiver for transmitting and receiving information using an antenna, a communication circuit, a communication processor, and the like and perform short-range communication with the vehicle. According to an embodiment, the communication unit 21 may perform NFC communication or UWB communication.

The output unit 22 may output information stored in the user terminal 20 in at least one of a visual manner, an audible manner, or a combination thereof. According to an embodiment, the output unit 22 may be implemented as a display device that adopts a liquid crystal display (LCD) panel, a light emitting diode (LED) panel, an organic light emitting diode (OLED) panel, a plasma display panel (PDP), or the like. The LCD may include a thin film transistor LCD (TFT-LCD). The output unit 22 may be implemented by being formed integrally with the input unit (not shown) by a touch screen panel (TSP).

The storage unit 23 may store at least one algorithm that performs calculation or execution of various commands for operating the user terminal 20 according to one embodiment of the present disclosure. The storage unit 23 may include at least one storage medium of a flash memory, a hard disc, a memory card, a ROM, a RAM, an EEPROM, a PROM, a magnetic memory, a magnetic disc, and an optical disc. The storage unit 23 may store driver information for a plurality of vehicles.

The control unit 24 may be implemented by various processing devices such as a microprocessor having a semiconductor chip capable of performing calculations or executions of various commands embedded therein and may control the operation of the user terminal 20 according to the embodiment. The control unit 24 may be electrically connected to the communication unit 21, the output unit 22, and the storage unit 23 through a wired cable or various circuits to transmit electrical signals including control commands and the like and may transmit and receive electrical signals including control commands and the like by various wireless communication networks such as a CAN.

In the vehicle control system 10 according to the embodiment, the user terminal 20 may operate as a digital key 20. Hereinafter, the digital key and the user terminal may be used as terms referring to the same component.

The digital key 20 may open and close the door provided in the vehicle 1, start or stop the vehicle 1, and execute various functions included in the vehicle 1 (e.g., as needed). The digital key 20 may be a device that may use one or more of low-power Bluetooth (BLE) communication and NFC.

One digital key 20 may be operated by being linked to a specific vehicle 1, and a plurality of digital keys 20 may be (e.g., selectively) linked to one vehicle 1 or one digital key 20 may be linked to a plurality of vehicles 1. In addition, there may be a case in which a plurality of digital keys 20 are linked to a plurality of vehicles 1.

In addition, the digital key 20 may be installed and operated in a device such as a smartphone, and there may be a case in which a plurality of digital keys 20 are installed in one smartphone. Although the embodiment describes an example in which the digital key 20 is installed and operated in the smartphone, the present disclosure is not limited thereto, and the digital key 20 may be (e.g., selectively) installed in a device other than the smartphone.

The digital key 20 may control the vehicle 1 and, to this end, may communicate with the vehicle 1 through low-power Bluetooth communication, UWB communication, wireless Internet network communication, or mobile communication network communication.

The digital key 20 may be manipulated by the user to perform various functions for controlling the vehicle 1 and manipulated to set one or more wireless anchors.

The digital key 20 may search for nearby wireless anchors and register the searched wireless anchors. That is, the digital key 20 may use various communication methods to search for wireless anchors that may be communicatively connected in a wireless communication manner. For example, when two wireless anchors are positioned near the digital key 20, one wireless anchor may perform communication through low-power Bluetooth communication and the other may perform communication through wireless Internet network communication, the digital key 20 may be communicatively connected to one of the two wireless anchors or communicatively connected to both wireless anchors.

In an embodiment, the wireless anchor may be the same component as the positioning module.

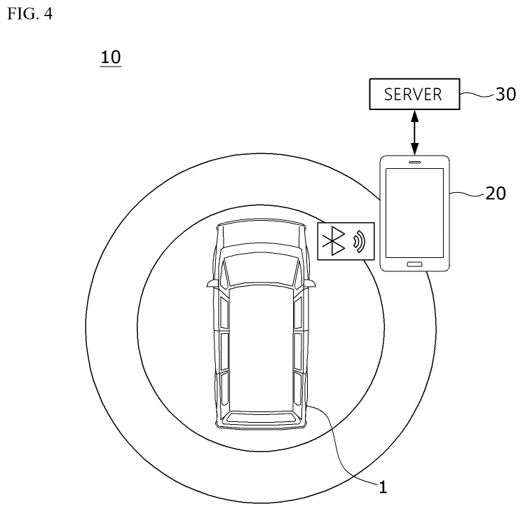

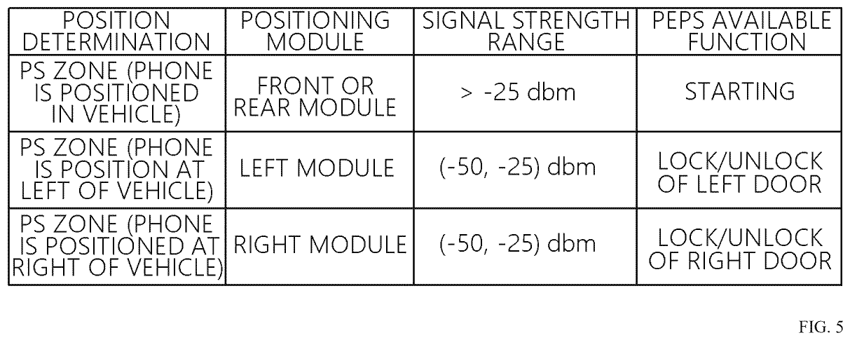

FIG. 4 is a conceptual diagram of the vehicle control system according to the embodiment. Referring to FIG. 4, in an embodiment, a server 30 may store a positioning pattern for positioning the relative position of the user terminal 20 with respect to the vehicle 1.

In an embodiment, the server 30 may be a cloud server and may authenticate the user terminal 20 using an ID and a password and allow login.

In an embodiment, the positioning pattern may include information about the strength range of a Bluetooth communication signal for each position of the positioning module. For example, the positioning pattern may include the strength range of a wireless communication signal at front, rear, left, and right sides of the vehicle 1.

When requested by the user terminal 20, the server 30 may search for positioning patterns corresponding to model identification information and user identification information and transmit the positioning patterns to the user terminal 20.

Alternatively, when the positioning patterns corresponding to the model identification information and the user identification information are not searched, the server 30 may search for a default positioning pattern corresponding to the model identification information and transmit the default positioning pattern to the user terminal 20.

The model identification information may include model information of the user terminal 20. The user identification information may include a user ID of the user terminal 20.

In an embodiment, the positioning pattern may be stored in the server 30 with the signal strength range set according to the pre-measurement results. The positioning pattern may be (e.g., basically) stored as the default pattern according to the model. The default pattern may be a representative positioning pattern of a specific model and provided when the positioning pattern corresponding to the user identification information is not searched, or in an initial pairing process for the PEPS function after the vehicle 1 is released. For example, the default pattern may be set according to the pre-positioning results for n representative models (n is a natural number) of manufacturers.

Alternatively, the server 30 may store a different positioning pattern for each user. In this case, the positioning pattern may be a user-customized positioning pattern. The positioning pattern may be pattern information that calibrates the default pattern according to the user's terminal 20 usage situations, habits, characteristics, or the like.

When there is a request from the user terminal 20, the server 30 may search for the stored positioning patterns and transmit the stored positioning patterns to the user terminal 20. According to the request from the user terminal 20, the server 30 may search for the positioning patterns corresponding to the model identification information and the user identification information and transmit the positioning patterns to the user terminal 20. However, when a positioning pattern that satisfies the corresponding conditions is not searched, the server 30 may search for a positioning pattern using (e.g., only) the model identification information and search for a positioning pattern corresponding to the model identification information, that is, the default pattern, and provide the positioning pattern to the user terminal 20.

The server 30 may update the stored positioning patterns using information included in a second update request. The server 30 may receive a request for the update of the positioning patterns from the user terminal 20. The update request may include model identification information, user identification information, and a new positioning pattern. The server 30 may update the default pattern corresponding to the model identification information to a new positioning pattern. Alternatively, the server 30 may update existing positioning patterns corresponding to the model identification information and the user identification information to a new positioning pattern.

When there is a request for the positioning pattern from the user terminal 20, the server 30 may search for the updated positioning pattern and provide the updated positioning pattern to the user terminal 20.

The user terminal 20 may receive the positioning patterns corresponding to the model identification information and the user identification information from the server 30 and transmit the positioning patterns to the vehicle 1. The user terminal 20 may log in to the server 30 using account information and perform pairing with the vehicle 1. The user terminal 20 that has completed pairing may request a positioning pattern from the logged-in server 30. The user terminal 20 may request the positioning pattern from the server 30 while transmitting model identification information and user identification information. The user terminal 20 may transmit the request information received from the server 30 to the vehicle 1 and transmit a Bluetooth signal to the positioning module of the vehicle 1 to perform an operation for performing a PEPS function.

In addition, the user terminal 20 may transmit the second update request including the model identification information, the user identification information, and the new positioning pattern to the server 30. The user terminal 20 may receive an update request for the positioning pattern from the vehicle 1. The user terminal 20 may display update request information and perform an update operation according to the user's input. When there is a user's input allowing an update, the user terminal 20 may request and receive a new positioning pattern from the vehicle 1. The user terminal 20 may match the new positioning pattern received from the vehicle 1 to the model identification information and user identification information to generate second update request information. The user terminal 20 may transmit the generated second update request information to the server 30 to request an update of the positioning pattern.

The vehicle 1 may compare the strength of the wireless communication signal received from the user terminal 20 with the positioning pattern to determine the position of the user terminal 20 and control an operation according to the result of position determination.

The vehicle 1 may perform a PEPS control operation according to the result of position determination. The vehicle 1 may initially provide a PEPS function when both passive entry and passive start conditions are satisfied at the same time.

In addition, the vehicle 1 may provide (e.g., only) the passive entry function when the passive entry conditions are satisfied and the passive start conditions are not satisfied.

In addition, the vehicle 1 may not provide any function when the passive start conditions are satisfied and the passive entry conditions are not satisfied.

FIG. 5 is a view for describing the positioning pattern according to the embodiment.

Referring to FIG. 5, the positioning pattern may be information that includes a position of the positioning module, a signal strength range, a providable PEPS function, and the result of position determination in a table format.

According to the positioning pattern of FIG. 5, when the strength of the Bluetooth signal measured by the positioning module disposed at the front or rear portion of the vehicle 1 exceeds −25 dbm (decibel-milliwatts), the vehicle 1 may determine that the user terminal 20 is positioned inside the vehicle 1 and provide the passive start function.

According to the positioning pattern of FIG. 5, when the strength of the Bluetooth signal measured by the positioning module disposed at the left side of the vehicle 1 is in the range of −50 dbm to −25 dbm, the vehicle 1 may determine that the user terminal 20 is positioned outside the left side of the vehicle 1 and provide the passive entry function.

According to the positioning pattern of FIG. 5, when the strength of the Bluetooth signal measured by the positioning module disposed at the right side of the vehicle 1 is in the range of −50 dbm to −25 dbm, the vehicle 1 may determine that the user terminal 20 is positioned outside the right side of the vehicle 1 and provide the automatic entry function.

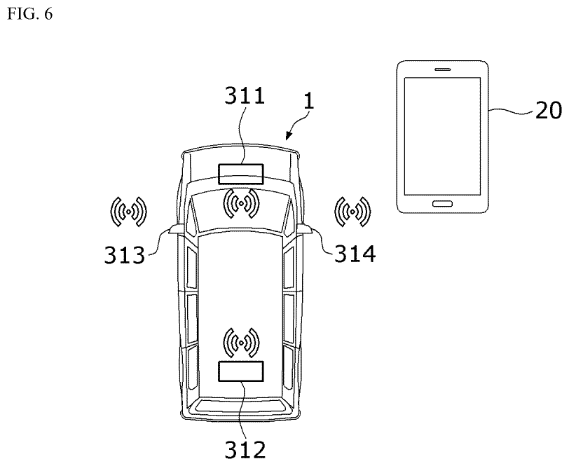

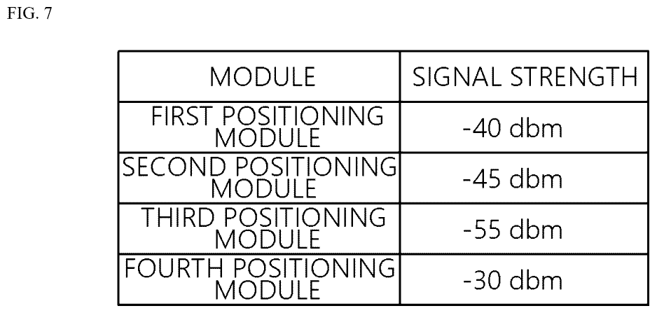

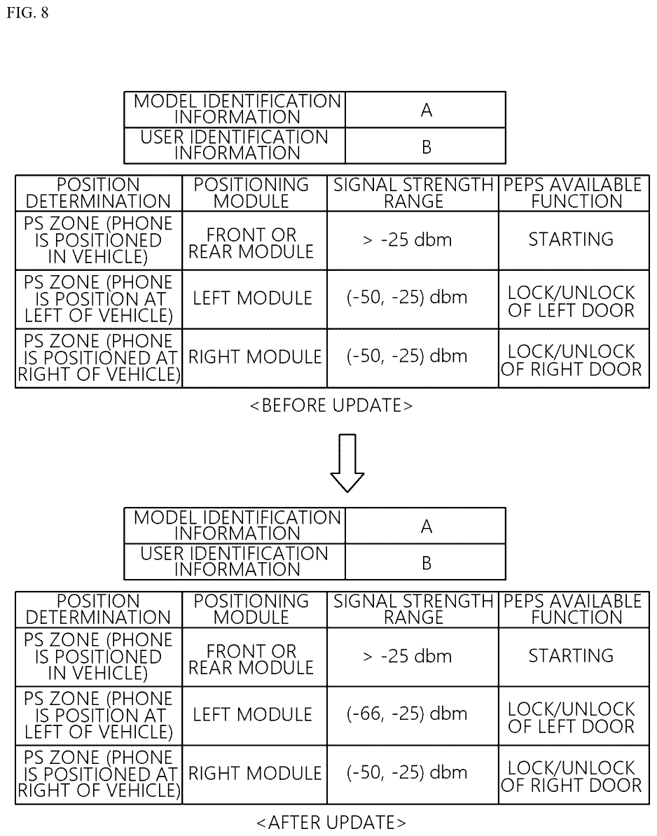

FIGS. 6 and 7 are views for describing the operation of the vehicle according to the embodiment.

Referring to FIG. 6, a first positioning module 311 is disposed at the front of the vehicle 1, a second positioning module 312 is disposed at the rear of the vehicle 1, a third positioning module 313 is disposed at the left side of the vehicle 1, and a fourth positioning module 314 is disposed at the right side of the vehicle 1. Each of the positioning modules 311 to 314 may receive a Bluetooth signal from a paired user terminal 20 and measure the strength of the received Bluetooth signal.

Referring to FIG. 7, the strength of a signal measured by the first positioning module 311 is −40 dbm, the strength of a signal measured by the second positioning module 312 is −45 dbm, the strength of a signal measured by the third positioning module 313 is −55 dbm, and the strength of a signal measured by the fourth positioning module 314 is −30 dbm. The processor may compare the measured strength of the Bluetooth signal as in FIG. 7 with the positioning pattern of FIG. 5. The vehicle 1 may determine that the measurement results of the fourth positioning module 314 satisfies the conditions of the positioning pattern and determine that the user terminal 20 is positioned outside the right side of the vehicle 1. The vehicle 1 may provide a corresponding passive entry function according to the result of position determination.

When the result of position determination is invalid, the vehicle 1 may transmit a first update request of the positioning pattern to the user terminal 20. At this time, the vehicle 1 may generate a new positioning pattern using the strength of the signal measured in the position determination process and transmit the new positioning pattern to the user terminal 20 together with the first update request.

In an embodiment, the validity of the result of position determination discloses (e.g., means) that the relative position of the user terminal 20 may be specified as the result of comparing the positioning result with the positioning pattern. Therefore, when the vehicle 1 may not specify the relative position of the user terminal 20 by comparing the positioning result with the positioning pattern, that is, when none of the positioning results is in the range of the signal strength of the positioning pattern, it may be determined that the result of position determination is invalid.

In addition, the vehicle 1 may determine that the result of position determination is invalid even when the passive start conditions are satisfied and the passive entry conditions are not satisfied. In this case, it is because the positioning module at the left and/or right side of the vehicle 1 may not receive a suitable Bluetooth signal even when it is determined that the user terminal 20 is positioned inside the vehicle 1.

For example, when the result of position determination of the vehicle 1 is invalid continuously a preset number of times or more, the vehicle 1 may transmit the first update request of the positioning pattern to the user terminal 20. The preset number of times may be set or changed according to various conditions and for example, set to 3. In this case, the vehicle 1 may store a previous positioning result together with the time stamp and signal strength.

The vehicle 1 may apply the strength of a signal having the smallest value among the strengths of signals measured in the position determination process to generate a new positioning pattern.

At this time, the vehicle 1 may detect a direction in which a door open button signal is input and update (e.g., only) the positioning pattern corresponding to the corresponding direction. When the door open button signal is input from a door sensor or the user terminal 20, the vehicle 1 may determine whether the door open button signal is input to a left door or right door of the vehicle 1.

For example, when the door open button signal is input to the left door, the vehicle 1 may update (e.g., only) the range of the signal strength of the positioning pattern corresponding to the third positioning module.

Alternatively, when the door open button signal is input to the right door, the vehicle 1 may update (e.g., only) the range of the signal strength of the positioning pattern corresponding to the fourth positioning module.

When receiving a first update request progress response from the user terminal 20, the vehicle 1 may generate a new positioning pattern and provide the new positioning pattern to the user terminal 20. The vehicle 1 may apply the strongest signal strength among the strengths of the signals during a period in which the result of position determination is invalid to generate a new positioning pattern.

FIG. 8 is a view for describing the operation of the vehicle according to the embodiment. Referring to FIG. 8, the vehicle 1 may generate a new positioning pattern using the previous positioning result when the result of position determination of the vehicle 1 is invalid (e.g., continuously) three times. When a signal strength value of the third positioning module measured in the position determination process three times is −66 dbm, −60 dbm, and 63 dbm, the vehicle 1 may update the range of the signal strength of the third positioning module using −66 dbm having the smallest signal strength value to generate a new positioning pattern.

For convenience, one or more figures are described by way of an example in which the steps are performed by a processor circuit. One or more of the steps of the example method of a figure, or portions thereof, may be performed by one or more other circuits. One or more of the steps of the example method of a figure may be omitted, performed in other orders, and/or otherwise modified, and/or one or more additional steps may be added.

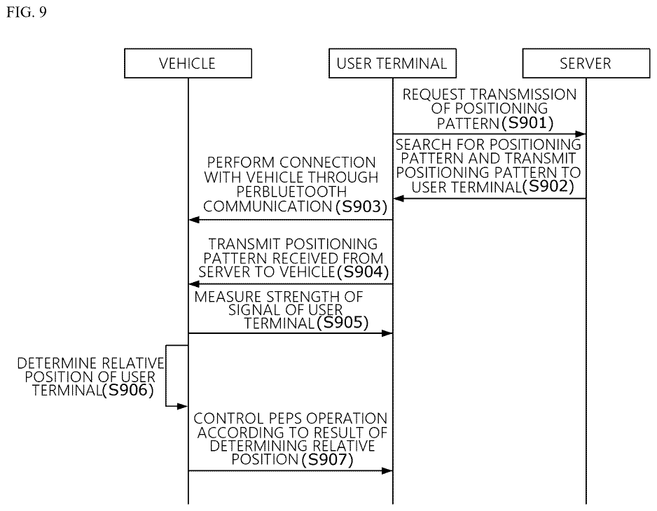

FIG. 9 is a flowchart of a vehicle control method according to an embodiment. Referring to FIG. 9, a user terminal logs in to a server using account information and requests transmission of positioning patterns. The user terminal requests transmission of positioning patterns in addition to model identification information and user identification information (S901).

Next, the server searches for positioning patterns corresponding to the model identification information and the user identification information and transmits the positioning patterns to the user terminal. At this time, when the positioning patterns corresponding to the model identification information and the user identification information are not searched, the server searches for a default positioning pattern corresponding to the model identification information and transmits the default positioning pattern to the user terminal (S902).

Next, the user terminal is connected to a vehicle through Bluetooth communication (S903).

Next, the user terminal transmits the positioning pattern received from the server to the vehicle (S904).

Next, the vehicle measures the strength of the signal using a Bluetooth signal output from the user terminal (S905).

Next, the vehicle compares the measured strength of the Bluetooth signal with the positioning pattern and determines a relative position of the user terminal (S906).

Next, the vehicle controls the operation of the vehicle to provide a PEPS function according to the result of determining the relative position (S907).

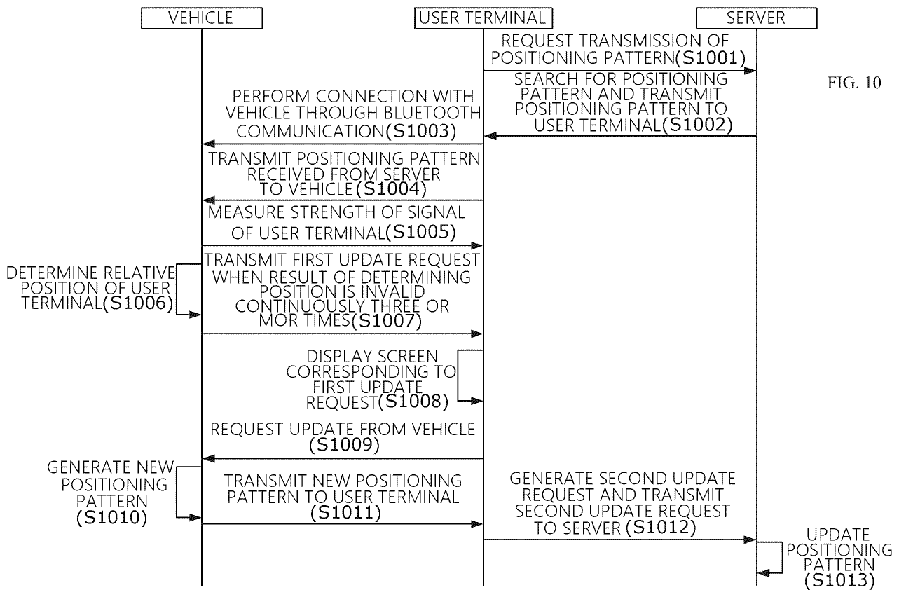

FIG. 10 is a flowchart of a vehicle control method according to another embodiment. Referring to FIG. 10, a user terminal logs in to a server using account information and requests transmission of positioning patterns. The user terminal requests transmission of positioning patterns in addition to model identification information and user identification information (S1001).

Next, the server searches for positioning patterns corresponding to the model identification information and the user identification information and transmits the positioning patterns to the user terminal. At this time, when the positioning patterns corresponding to the model identification information and the user identification information are not searched, the server searches for a default positioning pattern corresponding to the model identification information and transmits the default positioning pattern to the user terminal (S1002).

Next, the user terminal is connected to a vehicle through Bluetooth communication (S1003).

Next, the user terminal transmits the positioning pattern received from the server to the vehicle (S1004).

Next, the vehicle measures the strength of the signal using a Bluetooth signal output from the user terminal (S1005).

Next, the vehicle compares the measured strength of the Bluetooth signal with the positioning pattern and determines a relative position of the user terminal (S1006).

Next, the vehicle transmits a first update request of the positioning pattern to the user terminal when the result of determining the relative position is invalid. For example, the vehicle transmits the first update request when the result of position determination is invalid (e.g., continuously) three or more times (S1007).

Next, the user terminal displays a screen corresponding to the first update request (S1008).

Next, the user terminal requests the vehicle to perform the first update when receiving an input signal accepting the first update operation (S1009).

Next, when the vehicle receives the first update request from the user terminal, the vehicle generates a new positioning pattern using the strength of the signal measured in the position determination process (S1010).

Next, the vehicle transmits the new positioning pattern to the user terminal (S1011).

Next, the user terminal generates the second update request including the model identification information, the user identification information, and the new positioning pattern and transmits the second update request to the server (S1012).

Next, the server updates the stored positioning patterns using the information included in the second update request (S1013).

Conventionally, the PEPS function may (e.g., needs to) be provided using the representative positioning pattern results and positioning results stored for each manufacturer, and, alternatively, when the positioning results do not match the representative positioning pattern, calibration may (e.g., needs to) be performed while stopped at a specific position in order to receive the PEPS function.

However, according to the conventional method, a storage space of the positioning module for storing the representative positioning pattern is limited. Therefore, it may be limited to receiving the PEPS function using the positioning patterns optimized for various smartphone models, and therefore, there is an inconvenience in that calibration is performed manually for several seconds or more while stopped at a specific position.

According to an embodiment, customized positioning patterns optimized for various smartphone models and users may be stored (e.g., unlimitedly) in a cloud server. Therefore, positioning may be performed by (e.g., directly) receiving and using the positioning pattern from the cloud server when performing the positioning operation for the PEPS function, and the operation of the PEPS function may be controlled.

In addition, it is possible to provide a personalized PEPS function by reflecting positioning errors according to the user's smartphone usage situations and habits to update the positioning patterns in real time.

The term “˜unit” used in the present embodiment discloses (e.g., means) a software or hardware component such as a field-programmable gate array (FPGA) or an ASIC, and the “˜unit” performs (e.g., certain) roles. However, the “unit” is not limited to software or hardware. The “unit” may be configured to be disposed in an addressable storage medium and configured to reproduce one or more processors. Therefore, as an example, the “unit” is components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “˜units” may be combined into the smaller number of components and “unit” or separated into additional components and “units.” Additionally, the components and “˜units” may be implemented to reproduce one or more CPUs in a device or a security multimedia card.

A vehicle control system and method according to embodiments can perform active positioning using various signal patterns according to the strength of a signal of a smartphone that may vary depending on a user's smartphone usage situations, habits, or the like.

In addition, the active positioning can be performed using various signal patterns according to a model of the smartphone.

In addition, accurate positioning can be performed by updating the signal patterns.

Therefore, a (e.g., highly reliable) PEPS function can be provided to a vehicle's owner.

Although the present disclosure has been described above with reference to exemplary embodiments, one will understand that the present disclosure may be modified and changed variously without departing from the spirit and scope of the present disclosure as described in the appended claims.

What is claimed is:

1. A vehicle control system comprising:
a server configured to store a positioning pattern for positioning a relative position of a user terminal with respect to a vehicle;
the user terminal configured to receive the positioning pattern corresponding to model identification information and user identification information from the server and transmit the positioning pattern to the vehicle; and
the vehicle configured to compare a strength of a wireless communication signal, received signal strength indicator (RSSI), received from the user terminal with the positioning pattern to determine the position of the user terminal and control an operation according to a result of the position determination.

2. The vehicle control system of claim 1, wherein the positioning pattern includes a strength range of the wireless communication signal at front, rear, left, and right sides of the vehicle.

3. The vehicle control system of claim 1, wherein the server searches for the positioning patterns corresponding to the model identification information and the user identification information and transmits the positioning patterns to the user terminal upon request from the user terminal.

4. The vehicle control system of claim 3, wherein, when the positioning patterns corresponding to the model identification information and the user identification information are not searched, the server searches for a default positioning pattern corresponding to the model identification information and transmits the default positioning pattern to the user terminal.

5. The vehicle control system of claim 1, wherein, when the result of position determination is valid, the vehicle performs a passive-entry-passive-start (PEPS) control operation.

6. The vehicle control system of claim 1, wherein, when the result of position determination is invalid, the vehicle transmits a first update request of the positioning pattern to the user terminal.

7. The vehicle control system of claim 6, wherein, when the result of position determination is invalid, the vehicle generates a new positioning pattern using strengths of signals measured in the position determination process and transmits the new positioning pattern to the user terminal.

8. The vehicle control system of claim 7, wherein the vehicle applies a strength of a signal having the smallest value among the strengths of the signals measured in the position determination process to generate the new positioning pattern.

9. The vehicle control system of claim 7, wherein the user terminal transmits a second update request including the model identification information, the user identification information, and the new positioning pattern to the server.

10. The vehicle control system of claim 9, wherein the server updates the stored positioning patterns using the information included in the second update request.

11. A vehicle control method comprising:
requesting, by a user terminal, a positioning pattern from a server;
searching for, by the server, a corresponding positioning pattern according to the request and transmitting the positioning pattern to the user terminal;
receiving, by the user terminal, the positioning pattern and transmitting the positioning pattern to a vehicle;
measuring, by the vehicle, a strength of a wireless communication signal received from the user terminal;
comparing the strength of the signal measured by the vehicle with the positioning pattern and determining a position of the user terminal; and
controlling, by the vehicle, an operation according to a result of position determination.

12. The vehicle control method of claim 11, wherein the positioning pattern includes a strength range of the wireless communication signal at front, rear, left, and right sides of the vehicle.

13. The vehicle control method of claim 11, wherein the searching and transmitting of the positioning pattern includes searching for the positioning patterns corresponding to model identification information and user identification information and transmitting the positioning patterns to the user terminal.

14. The vehicle control method of claim 13, wherein the searching and transmitting of the positioning pattern includes searching for a default positioning pattern corresponding to the model identification information and transmitting the default positioning pattern to the user terminal when the positioning patterns corresponding to the model identification information and the user identification information are not searched.

15. The vehicle control method of claim 11, wherein the controlling of the operation includes performing a passive-entry-passive-start (PEPS) control operation when the result of position determination is valid.

16. The vehicle control method of claim 11, further comprising, after the determining of the position, transmitting, by the vehicle, a first update request of the positioning pattern to the user terminal when the result of position determination is invalid.

17. The vehicle control method of claim 16, wherein the transmitting of the first update request includes:
generating a new positioning pattern using a strength of a signal measured in the position determination process; and
transmitting the new positioning pattern to the user terminal according to a response of the user terminal.

18. The vehicle control method of claim 17, wherein the generating of the new positioning pattern includes applying a strength of a signal having the smallest value among the strengths of the signals measured in the position determination process to generate the new positioning pattern.

19. The vehicle control method of claim 17, further comprising:
after the transmitting of the first update request,
generating, by the user terminal, a second update request including model identification information, user identification information, and the new positioning pattern; and
transmitting the second update request to the server.

20. The vehicle control method of claim 19, further comprising,
after the transmitting of the second update request to the server,
updating, by the server, stored positioning patterns using the information included in the second update request.
